(19) United States
(12) Patent Application Publication
(10) Pub. No.: US 2025/0292164 A1
(43) Pub. Date: Sep. 18, 2025

(54) ANALYSIS DEVICE, ANALYSIS SYSTEM, ANALYSIS METHOD, PROGRAM, AND WORKWEAR

(71) Applicant: NEC Corporation, Tokyo (JP)

(72) Inventor: Nobuyuki Harabe, Tokyo (JP)

(73) Assignee: NEC Corporation, Tokyo (JP)

(21) Appl. No.: 19/062,277

(22) Filed: Feb. 25, 2025

(30) Foreign Application Priority Data
Mar. 13, 2024 (JP) 2024-038780

(51) Int. Cl. G06Q 10/063; G06T 7/73; G06V 20/52; G06V 40/20

(52) U.S. Cl. CPC G06Q 10/063; G06T 7/73; G06V 20/52; G06V 40/20; G06T 2207/30196; G06T 2207/30204; G06T 2207/30232

(57) ABSTRACT

An analysis device acquires an image including a worker and a marker. The marker is attached to the worker and indicates an identifier unique to the worker. The analysis device identifies the worker based on the identifier. The analysis device specifies work content based on a position of the marker. The analysis device outputs data including the identified worker and the specified work content that are linked to each other.

### CROSS-REFERENCE TO RELATED APPLICATIONS

The present application claims priority to Japanese Patent Application No. 2024-038780, filed Mar. 13, 2024, the contents of which are incorporated herein by reference.

### BACKGROUND

### Technical Field

This disclosure relates to an analysis device, an analysis system, an analysis method, a program, and a workwear.

### Background Art

Japanese Unexamined Patent Application, First Publication No. 2000-180162 A (hereinafter Patent document 1) discloses an image processing device that, in order to specify the work content of a worker, attaches a marker to a worker, obtains the trajectory of the marker's movement, and compares the characteristics of the trajectory with the characteristics of a reference trajectory that is stored in advance for each task to specify the work content of the worker.

### SUMMARY

In a workplace where many workers come and go and each person performs a wide variety of work content simultaneously, workers often wear the same or similar workwear, which can lead to errors in specifying workers based on their appearance characteristics. As a result, there is a problem that errors occur in linking workers with work content. However, Patent Document 1 does not disclose a method for specifying workers.

An example object of the present disclosure is to provide an analysis device, analysis system, analysis method, program, and a workwear that solve the above-mentioned problems.

An analysis device according to one example aspect of the present disclosure includes: a memory configured to store instructions; and a processor configured to execute the instructions to: acquire an image including a worker and a marker, the marker being attached to the worker and indicating an identifier unique to the worker; identify the worker based on the identifier; specify work content based on a position of the marker; and output data including the identified worker and the specified work content that are linked to each other.

An analysis system according to one example aspect of the present disclosure includes: a camera configured to photograph a worker and obtain an image including the worker and a marker, the marker being attached to the worker and indicating an identifier unique to the worker; a memory configured to store instructions; a processor configured to execute the instructions to identify the worker based on the identifier, specify the work content based on a position of the marker, and output data including the identified worker and the specified work content that are linked to each other; and a terminal configured to present the data to a user.

An analysis method according to one example aspect of the present disclosure includes: acquiring an image including a worker and a marker, the marker being attached to the worker and indicating an identifier unique to the worker; identifying the worker based on the identifier; specifying work content based on a position of the marker; and outputting data including the identified worker and the specified work content that are linked to each other.

A program according to one example aspect of the present disclosure is a program for causing a computer to execute: acquiring an image including a worker and a marker, the marker being attached to the worker and indicating an identifier unique to the worker; identifying the worker based on the identifier; specifying work content based on a position of the marker; and outputting data including the identified worker and the specified work content that are linked to each other. The program may be stored in a non-transitory computer-readable recording medium.

A workwear according to one aspect of the present disclosure includes: a clothing body for a worker to wear, and a marker attached to the clothing body and indicating an identifier unique to the worker.

### BRIEF DESCRIPTION OF THE DRAWINGS

FIG. 1 is an analysis system according to some example embodiments of the present disclosure.

FIG. 2 is an example in which an analysis system according to some example embodiments of the present disclosure is applied to an application in which the analysis system analyzes the work content and efficiency of a worker performing multiple tasks in a work area of a logistics warehouse.

FIG. 3 is a diagram showing an example in which a marker according to some example embodiments of the present disclosure is a two-dimensional barcode.

FIG. 4 is a diagram showing another example in which a marker according to some example embodiments of the present disclosure is a two-dimensional barcode.

FIG. 5 is a diagram showing a hardware configuration of an analysis device according to some example embodiments of the present disclosure.

FIG. 6 is a block diagram illustrating an analysis device according to some example embodiments of the present disclosure.

FIG. 7 is a diagram showing an example structure of ID data according to some example embodiments of the present disclosure.

FIG. 8 is a diagram showing an example structure of work data according to some example embodiments of the present disclosure.

FIG. 9 is a diagram showing a flow of analysis processing by an analysis device according to some example embodiments of the present disclosure.

FIG. 10 is a diagram showing an example of an analysis result by an analysis device according to some example embodiments of the present disclosure.

FIG. 11 is a diagram showing a flow for specifying work content by an analysis device according to some example embodiments of the present disclosure.

FIG. 12 is a schematic diagram of processing for specifying work content according to some example embodiments of the present disclosure.

FIG. 13 is a diagram showing an example in which the marker is an LED according to some example embodiments of the present disclosure.

FIG. 14 is a diagram showing an example of the configuration of an analysis device (control unit of analysis device) according to some example embodiments of the present disclosure.

FIG. 15 is a diagram showing the processing flow by an analysis device (control unit of analysis device) according to some example embodiments of the present disclosure.

### DETAILED DESCRIPTION OF THE INVENTION

Below, several example embodiments of the present disclosure will be described with reference to the drawings.

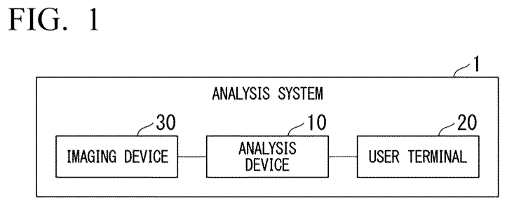

FIG. 1 shows an analysis system 1 according to several example embodiments of the present disclosure. The analysis system 1 includes an analysis device (work analysis device) 10, a user terminal (operation unit, terminal) 20, and an imaging device (image acquisition unit) 30.

The imaging device 30 may be a camera. The imaging device 30 may be positioned so that the entire area in which the worker moves in the workplace is captured. The imaging device 30 captures an image of an analysis target such as a worker, and acquires video data including multiple image frames (images) arranged in chronological order.

The analysis device 10 may be an information processing device such as a server. The analysis device 10 acquires video data from the imaging device 30. The analysis device 10 analyzes the video data to obtain an analysis result in which the worker and the work content are linked. The analysis device 10 outputs the analysis result to the user terminal 20.

The user terminal 20 may be a personal computer that is configured with a keyboard, mouse, monitor, and the like. The user terminal 20 acquires information input by the user U by operating the keyboard, mouse, and the like. The user terminal 20 also presents information such as analysis results to the user U via a monitor, and the like.

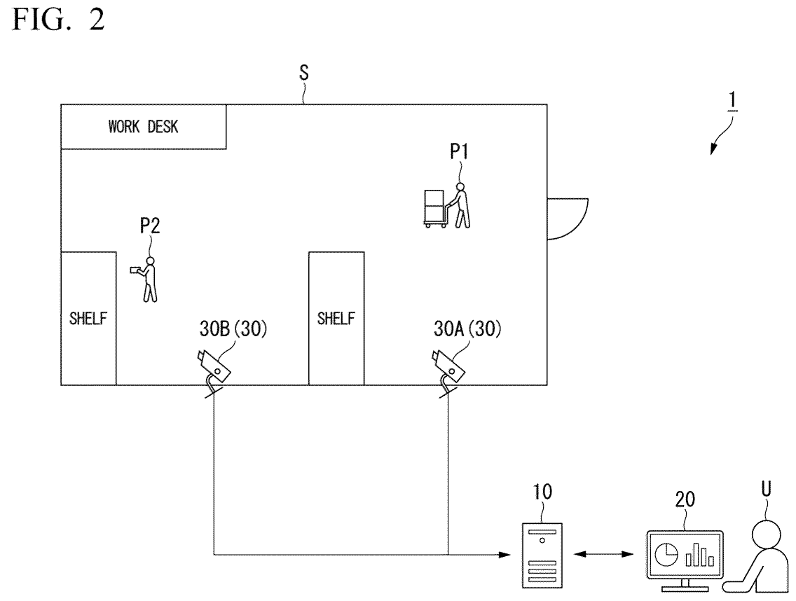

FIG. 2 shows an example in which the analysis system 1 is applied to an application in which the work contents and efficiency of workers P1 and P2 performing multiple tasks in a work area of a logistics warehouse S are analyzed. In the example of FIG. 2, shelves and a work desk are arranged in the logistics warehouse S. Workers P1 and P2 are performing work in the logistics warehouse S. Worker P1 is performing the work of transporting luggage. Worker P2 is performing the work of storing luggage on the shelves. Two imaging devices 30A (30) and 30B (30) are arranged in the logistics warehouse S. In the example of FIG. 2, the imaging device 30A is capturing an image of the worker P1, who is the subject of analysis. The imaging device 30B is capturing an image of a worker P2, who is another subject of analysis. The imaging device 30A may capture images of both the worker P1 and the worker P2.

The analysis device 10 analyzes image data showing the worker P1, identifies the worker P1, determines the position of the worker P1, and determines that the work being performed by the worker P1 is carrying luggage. Similarly, the analysis system 1 analyzes image data showing the worker P2, identifies the worker P2, determines the position of the worker P2, and determines that the work being performed by the worker P2 is storing luggage on a shelf. The analysis device 10 may analyze image data showing the workers P1 and P2.

The analysis system 1 is not limited to application to a work site in a logistics warehouse. The analysis system 1 may be applied to other workplaces where many workers come and go, such as assembly plants and construction sites, and where each worker performs a wide variety of tasks simultaneously.

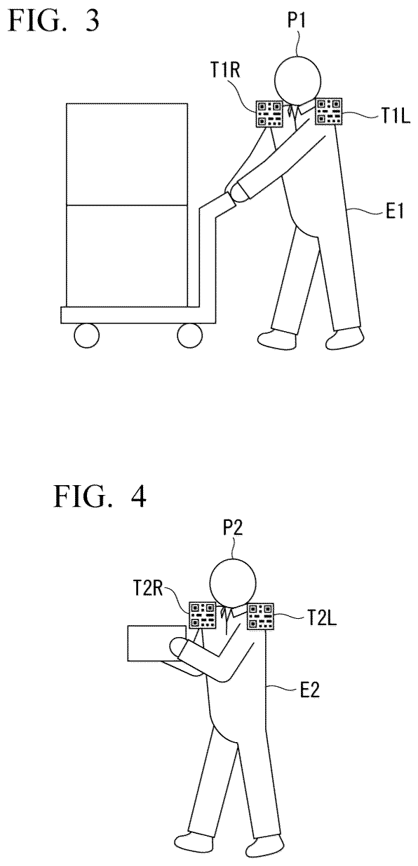

FIG. 3 shows details of worker P1 shown in FIG. 2. FIG. 4 shows details of worker P2 shown in FIG. 2. FIG. 3 and FIG. 4 show an example in which the markers according to some example embodiments of the present disclosure are two-dimensional barcodes. Two-dimensional barcodes T1R and T1L are attached to worker P1. Two-dimensional barcodes T2R and T2L are attached to worker P2. When no particular distinction is made, the two-dimensional barcodes T1R, T1L, T2R, and T2L are referred to as two-dimensional barcode T.

The two-dimensional barcode TIR is attached to the right shoulder of the worker P1, that is, at a position corresponding to the right shoulder of the workwear (clothing body, clothes, clothing product) E1 worn by the worker P1. The two-dimensional barcode T1L is attached to the left shoulder of the worker P1, that is, at a position corresponding to the left shoulder of the workwear E1 worn by the worker P1. More specifically, the two-dimensional barcode T1R is attached to a position corresponding to the right shoulder joint of the worker P1. Also, the two-dimensional barcode T1L is attached to a position corresponding to the left shoulder joint of the worker P1.

The two-dimensional barcode T2R is attached to the right shoulder of the worker P2, that is, at a position corresponding to the right shoulder of the workwear (clothing body, clothes, clothing product) E2 worn by the worker P2. Also, the two-dimensional barcode T2L is attached to the left shoulder of the worker P2, that is, at a position corresponding to the left shoulder of the workwear E2 worn by the worker P2. More specifically, the two-dimensional barcode T2R is attached to a position corresponding to the right shoulder joint of the worker P2. Also, the two-dimensional barcode T2L is attached to a position corresponding to the left shoulder joint of the worker P2.

The position where the two-dimensional barcode T is attached is not limited to the position corresponding to the shoulder joint. The two-dimensional barcode T may be attached to a position corresponding to another joint such as the elbow or knee. The position of the two-dimensional barcode T may be another position that is a feature point for the worker's posture recognition process. The two-dimensional barcodes T1 and T2 may be QR codes (registered trademark). The two-dimensional barcodes T1 and T2 each have a different unique pattern. The two-dimensional barcode T has embedded therein information indicating a worker ID (identifier, worker identifier) and a joint ID (feature point identifier, joint identifier).

The worker ID is an identifier unique to a worker and is different for each worker. Therefore, the worker can be identified from the worker ID. The joint ID indicates the type of joint at the position where the two-dimensional barcode Tis attached.

For example, the two-dimensional barcode TIR has embedded therein a worker ID indicating the worker P1 and a joint ID indicating the right shoulder (right shoulder joint). The two-dimensional barcode T1L has embedded therein a worker ID indicating the worker P1 and a joint ID indicating the left shoulder (left shoulder joint). The worker ID of the two-dimensional barcode T1L is the same as the worker ID of the two-dimensional barcode T1R. That is, each of the two-dimensional barcodes T1 and T2 contains the same identifier for identifying worker P1.

The two-dimensional barcode T2R has embedded therein a worker ID indicating the worker P2 and a joint ID indicating the right shoulder (right shoulder joint). The two-dimensional barcode T2L has embedded therein a worker ID indicating the worker P2 and a joint ID indicating the left shoulder (left shoulder joint). The worker ID of the two-dimensional barcode T2L is the same as the worker ID of the two-dimensional barcode T2R. The worker IDs of the two-dimensional barcodes T2R and T2L are different from the worker IDs of the two-dimensional barcodes T1R and T1L.

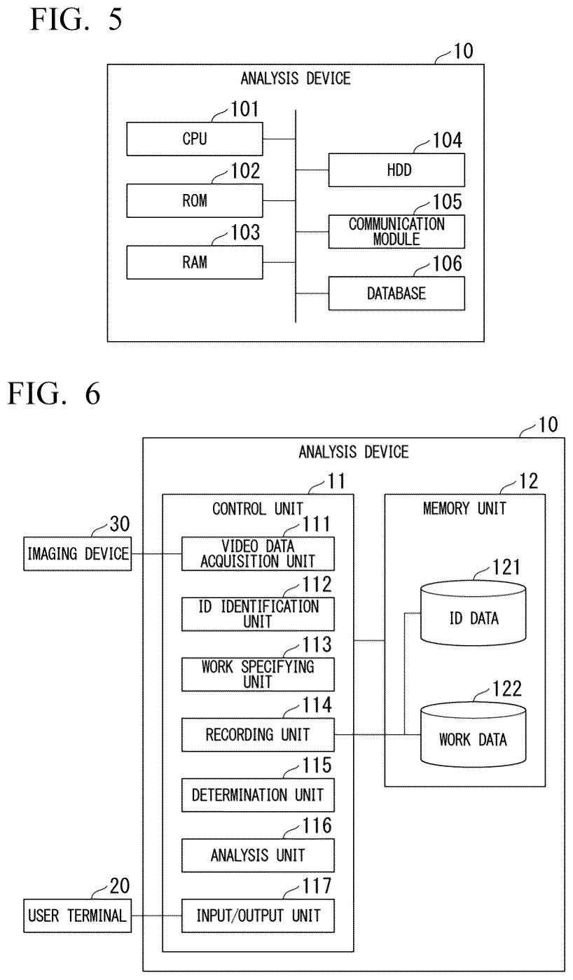

FIG. 5 is a diagram showing the hardware configuration of an analysis device 10 according to some example embodiments of the present disclosure. As shown in FIG. 5, the analysis device 10 is a computer equipped with various hardware components such as a central processing unit (CPU) 101, a read only memory (ROM) 102, a random access memory (RAM) 103, a hard disk drive (HDD) 104, a communication module 105, and a database 106. The user terminal 20 may also have a similar hardware configuration.

FIG. 6 shows an analysis device 10 according to some example embodiments of the present disclosure. The analysis device 10 includes a control unit 11 and a memory unit 12. The control unit 11 includes a video data acquisition unit 111, an ID identification unit 112, a work specifying unit 113, a recording unit 114, a determination unit 115, an analysis unit 116, and an input/output unit 117.

The analysis device 10 performs the functions of the video data acquisition unit 111, the ID identification unit 112, the work specifying unit 113, the recording unit 114, the determination unit 115, the analysis unit 116, and the input/output unit (output unit) 117 by the CPU executing a processing program stored in the memory. The memory unit 12 may be configured as a storage device such as a hard disk. The memory unit 12 has an ID data storage area 121 that stores ID data, and a work data storage area 122 that stores work data.

The video data acquisition unit 111 acquires video data from the imaging device 30.

The ID identification unit 112 analyzes the video data to identify the position of the two-dimensional barcode attached to the worker. The ID identification unit 112 also analyzes the video data to recognize information embedded in the two-dimensional barcode and identify ID information including the worker ID and joint ID. The ID identification unit 112 generates ID data including the position of the two-dimensional barcode and the ID information linked to each other. The ID data may include only one of the position of the two-dimensional barcode and the ID information. The ID data may include at least one of the position of the two-dimensional barcode and the ID information, and other information.

The work specifying unit 113 specifies the position of the worker and the work content of the worker from the video data and the ID data. The work specifying unit 113 may specify only one of the position of the worker and the work content of the worker. More specifically, the work specifying unit 113 specifies the work content based at least on the position of the two-dimensional barcode. The work specifying unit 113 specifies the type of joint based on the joint ID. The work specifying unit 113 specifies a plurality of positions of the worker's joints from the video data by image recognition. The work specifying unit 113 specifies the work content based on: at least some of the positions of the worker's joints specified by image recognition; and the positions of the worker's joints specified based on the position of the two-dimensional barcode. The work specifying unit 113 replaces the positions of the worker's joints specified by image recognition that indicate the same joints as the joints of the worker specified based on the position of the two-dimensional barcode, with the positions of the worker's joints specified based on the position of the two-dimensional barcode.

The work specifying unit 113 distinguishes the positions of the joints specified from the video data for each worker using the worker ID. The work specifying unit 113 generates work data including the positions of the workers and the work content of the workers that are linked to each other. The work data may include at least either of positions of the workers or the work content of the workers. The work data may include at least either of the positions of the workers or the work content of the workers, and other information.

The recording unit 114 records the ID data in the ID data storage area 121 of the storage unit 12. The recording unit 114 records the work data in the work data storage area 122 of the storage unit 12.

The determination unit 115 determines whether the analysis of the video data is complete.

The analysis unit 116 analyzes the work content of the workers from the ID data and the work data, and generates analysis results such as data that arranges the work content for each worker in chronological order.

The input/output unit 117 transmits and receives various information to and from the user terminal 20. The input/output unit 117 transmits data indicating the analysis results to the user terminal 20. A user using the user terminal 20 can analyze the efficiency of the workers based on the analysis results.

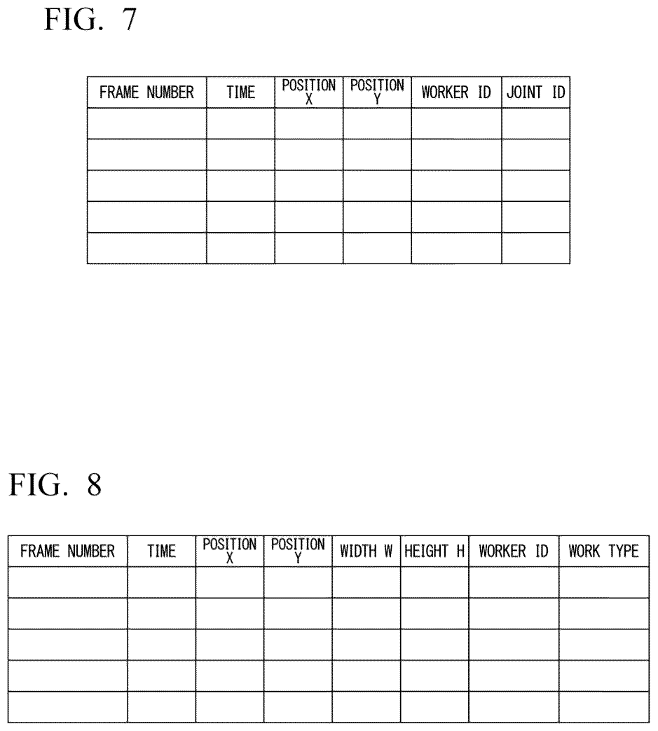

FIG. 7 is a diagram showing an example of the structure of ID data according to some example embodiments of the present disclosure. As described above, the ID data indicates the position and ID information of the two-dimensional barcode, and is generated based on the identification result by the ID identification unit 112.

In the example of FIG. 7, the frame number is a number for identifying a frame image in the video data. The time indicates the time when the frame image was captured. Position X and position Y indicate the position of the two-dimensional barcode, i.e., the position of the worker. Position X may be longitude. Position Y may be latitude. Position X and position Y may be a coordinate in one direction with a specific position as the origin, and a coordinate in a direction perpendicular to the one direction with the specific position as the origin, respectively. The worker ID is an identifier indicating the worker. The worker ID may be a number indicating the worker. The worker ID may be the name of the worker.

FIG. 8 is a diagram showing an example of the structure of work data according to some example embodiments of the present disclosure. As described above, work data indicates the position and work content of a worker, and is generated based on the identification result by the work specifying unit 113.

In the example of FIG. 8, the frame number, time, position X, and position Y are the same as those shown in the example of FIG. 3. Height H indicates the height direction position of the two-dimensional barcode, that is, the height direction position of the worker. Position H may be altitude. Position H may be a height direction coordinate with a specific position as the origin. Work type indicates the type of work content. Positions X and Y may be the position of the worker (e.g., the intersection of the central axis of the body and the floor surface), width W may be the width of the worker (e.g., shoulder width), and height H may be the height of the worker (e.g., height). The work specifying unit 113 may identify the positions X and Y and width W of the worker from the video data by image recognition.

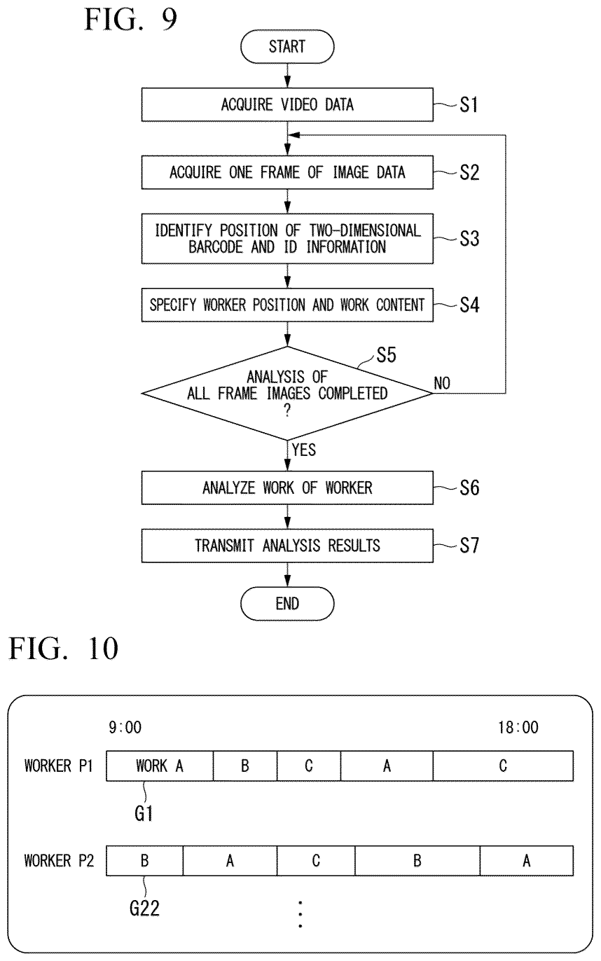

With reference to FIG. 9, the flow of analysis processing according to some example embodiments of the present disclosure will be described. FIG. 9 is a diagram showing a flow of an analysis process by the analysis device 10 according to some example embodiments of the present disclosure. The analysis process may be executed in response to a start instruction from a user via the user terminal 20.

First, the control unit 11 (video data acquisition unit 111) acquires video data including a plurality of frame images of the worker to be analyzed, from the imaging device 30 (step S1).

Next, the control unit 11 (ID identification unit 112, work specifying unit 113) acquires one frame of image data from the acquired video data in the order of shooting time (step S2). In addition, the control unit 11 (recording unit 114) stores the time when the acquired one frame image was captured, in the ID data storage area 121 and the work data storage area 122 of the storage unit 12.

Next, the control unit 11 (ID identification unit 112) applies image recognition technology or the like to the acquired one frame image to identify the position of the two-dimensional barcode and the ID information (step S3). The control unit 11 (recording unit 114) stores the identification result in the ID data storage area 121 of the storage unit 12.

The control unit 11 (work specifying unit 113) then applies image recognition technology or the like to the acquired one frame image to specify the worker's position and the work content (step S4). The control unit 11 (recording unit 114) stores the identification result in the work data storage area 122 of the storage unit 12.

The control unit 11 (determination unit 115) then determines whether analysis of all frame images included in the video data has been completed (step S5). If the control unit 11 determines that analysis of all frame images has not been completed (NO in step S5), it repeats the processing of steps S2 to S4. If the control unit 11 determines that analysis of all frame images to be analyzed has been completed (YES in step S5), the processing proceeds to step S6.

Next, the control unit 11 (analysis unit 116) analyzes the work of the worker from the ID data and the work data (step S6).

Next, the control unit 11 (input/output unit 117) transmits the analysis results to the user terminal 20 (step S7). When steps S1 to S7 are completed, the analysis process ends.

With reference to FIG. 10, an example of the analysis results by the analysis device 10 in some example embodiments of the present disclosure will be described. FIG. 10 shows an example of the analysis results displayed on the user terminal 20. In the example of FIG. 10, the analysis results include graphs G1 and G2 in which the work contents are arranged in chronological order. The graphs G1 and G2 are created for each worker. The graph G1 shows that the worker P1 performed work A, work B, work C, work A, and work C in that order during the period from 9:00 a.m. (9:00) to 6:00 p.m. (18:00). Graph G2 shows that worker P2 performed work B, work A, work C, work B, and work A in that order during the period from 9:00 a.m. to 6:00 p.m.

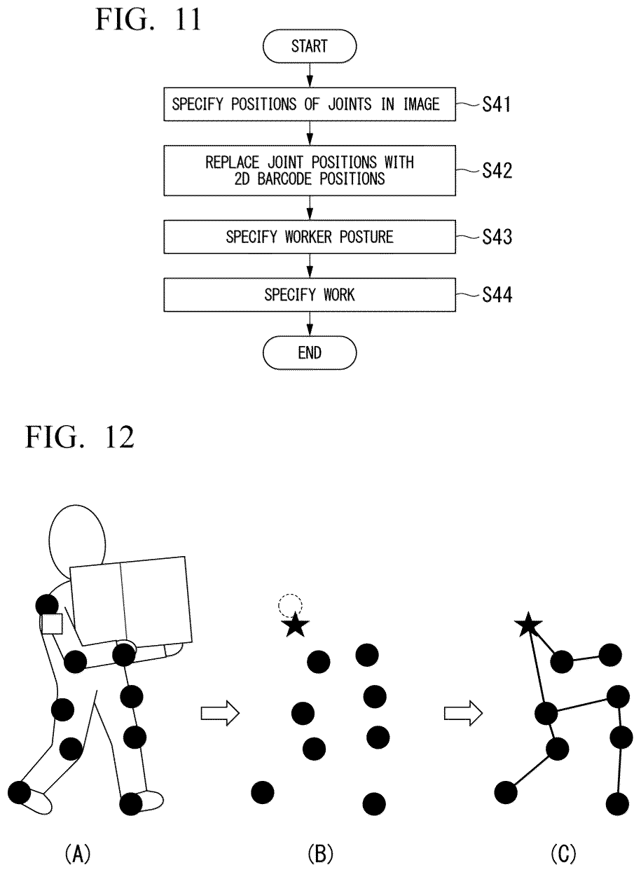

Next, the process for identifying the work content in step S4 of FIG. 9 will be described in more detail with reference to FIG. 11 and FIG. 12. FIG. 11 is a diagram showing a flow for specifying work content by the analysis device 10 according to some example embodiments of the present disclosure. FIG. 12 is a schematic diagram of the process for specifying work content according to some example embodiments of the present disclosure.

First, the work specifying unit 113 specifies the positions of multiple joints of the worker by applying image recognition technology or the like to the image of the worker shown in the frame image included in the video data (step S41). The number of joints specified by the work specifying unit 113 is not particularly limited. The work specifying unit 113 may identify all of the joints included in the image of the worker, or may identify some of the joints included in the image of the worker. In the example of part (A) of FIG. 12, the circles indicate the positions of the joints specified by image recognition. The square mark indicates a two-dimensional barcode attached at a position corresponding to the worker's right shoulder joint.

Next, the work specifying unit 113 replaces the positions of the worker's joints specified by image recognition, which indicate the same joints as the joints of the worker specified based on the positions of the two-dimensional barcodes included in the ID data, with the positions of the worker's joints specified based on the positions of the two-dimensional barcodes (step S42). By using the positions of the worker's joints specified based on the positions of the two-dimensional barcodes, the accuracy of specifying the joint positions is improved. In addition, because the type of joint can be specified using the joint ID, it is possible to prevent errors in specifying the joints. In the example of part (B) of FIG. 12, the star mark indicates the position of the worker's right shoulder joint specified based on the position of the two-dimensional barcode. The dotted circle indicates the position of the worker's right shoulder joint specified by image recognition. The position of the worker's right shoulder joint specified by image recognition is excluded, and is not used in subsequent processing.

Next, the work specifying unit 113 generates a human figure by connecting the positions of the joints specified in step S42, and specifies the posture of the worker based on the shape of the generated human figure (step S43). The work specifying unit 113 may further identify the position of the worker based on the ID information of the ID data. Part (C) of FIG. 12 shows an example of a human figure formed by connecting the positions of the joints.

Next, the work specifying unit 113 specifies the work content (work type) of the worker based on the characteristics of the posture specified in step S43 (step S44). The work specifying unit 113 may compare the specified posture with a plurality of reference posture patterns, and specify the work content associated with the posture pattern closest to the specified posture as the work content of the worker. When steps S41 to S44 are completed, the process for specifying the work content ends.

Above, several example embodiments of the present disclosure have been described. According to some example embodiments of the present disclosure, the identification of the worker is performed using the ID information of the two-dimensional barcode, not the appearance feature, so that it is possible to suppress errors in specifying the worker even when the workers are wearing the same or similar workwear. In addition, based on the position and ID information of the two-dimensional barcode, the joint points of each worker are linked to a human figure, and the position and posture of each worker are recognized, so that it is easy to specify the work content of each worker even when the workers are close to each other. Therefore, in a workplace where many workers come and go and each person is performing a wide variety of work content simultaneously, it is possible to improve the recognition accuracy of the work content while suppressing errors in linking the worker and the work content by the device that analyzes the work content of the worker.

In some example embodiments of the present disclosure, the work specifying unit 113 does not need to specify the position of the joint by applying image recognition technology or the like. In this case, the work specifying unit 113 may generate a human figure by connecting the positions of multiple joints specified by the positions of multiple two-dimensional barcodes, and specify the work content based on the shape of the generated human figure.

The marker is not limited to a two-dimensional barcode, and may be in other forms that can indicate a worker ID and a joint ID that can be recognized by an imaging device such as a camera.

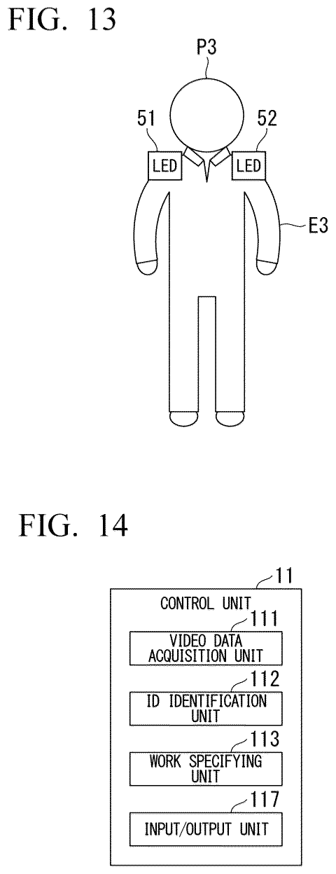

FIG. 13 shows an example in which the marker according to some example embodiments of the present disclosure is an LED. In the example of FIG. 13, the LED 51 is attached to a position corresponding to the right shoulder joint of the workwear (main body, clothes) E3 worn by the worker P3. The LED 52 is attached to a position corresponding to the left shoulder joint of the workwear (main body, clothes) E3 worn by the worker P3.

Each of the LEDs 51 and 52 may alternately emit light in a unique color indicating the worker ID and a unique color indicating the joint ID. More specifically, the LED 51 may alternately emit light in a unique color indicating the worker ID indicating the worker P3 and a unique color indicating the right shoulder joint ID. The LED 52 may alternately emit light in a unique color indicating the worker ID of the worker P3 and in a unique color indicating the joint ID of the left shoulder. Each of the LEDs 51 and 52 may have two or more LEDs, one of which may emit light in a unique color indicating the worker ID and the other may emit light in a unique color indicating the joint ID. The color indicating the worker ID of the worker P3 is different from the color indicating the right shoulder joint ID and the color indicating the left shoulder joint ID. The color indicating the right shoulder joint ID is also different from the color indicating the left shoulder joint ID.

Each of the LEDs 51 and 52 may alternately flash a pattern indicating the worker ID and a unique pattern (in a color) indicating the joint ID. More specifically, the LED 51 alternately flashes a unique pattern indicating the worker ID of the worker P3 and in a pattern indicating the right shoulder joint ID. The LED 52 alternately flashes a unique pattern indicating the worker ID of the worker P3 and a unique pattern indicating the left shoulder joint ID. Each of the LEDs 51 and 52 may have two or more LEDs, one of which flashes in a pattern indicating the worker ID, and the other flashes in a pattern indicating the joint ID. The pattern indicating the worker ID of worker P3 is different from the patterns indicating the joint IDs of the right and left shoulders. The pattern indicating the joint ID of the right shoulder is different from the pattern indicating the joint ID of the left shoulder.

Each of the LEDs 51 and 52 may emit light in a unique color indicating the worker ID and flash in a unique pattern (in a color) indicating the joint ID. Conversely, each of the LEDs 51 and 52 may flash in a unique pattern indicating the worker ID and emit light in a unique color indicating the joint ID.

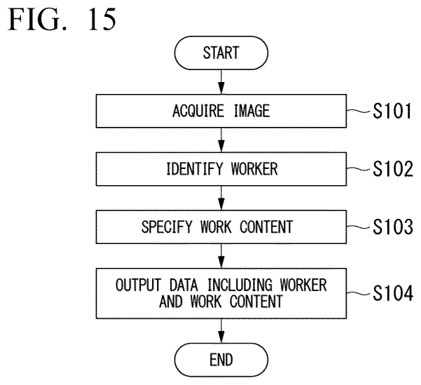

FIG. 14 is a diagram showing an example of the configuration of an analysis device 10 (control unit 11 of analysis device 10) according to some example embodiments of the present disclosure. FIG. 15 is a diagram showing an example of a processing flow by the analysis device 10 (control unit 11 of analysis device 10) shown in FIG. 14.

The analysis device 10 (control unit 11 of analysis device 10) realizes at least the functions of a video data acquisition unit (image acquisition means) 111, an ID identification unit (identification means) 112, a work specifying unit (specifying means) 113, and an input/output unit (output means) 117.

The video data acquisition unit 111 acquires an image including a worker and a marker attached to the worker that indicates an identifier unique to the worker (step S101). The ID identification unit 112 identifies the worker based on the identifier unique to the worker (step S102). The work specifying unit 113 specifies the work content based on the position of the marker (step S103). The input/output unit 117 outputs data including the identified worker and the specified work content that are linked to each other (step S104).

Each of the above-mentioned devices has a computer system inside. The above-mentioned processes are stored in a computer-readable recording medium in the form of a program, and the above processes are performed by the computer reading and executing the program. Here, the computer-readable recording medium refers to a magnetic disk, a magneto-optical disk, a CD-ROM, a DVD-ROM, a semiconductor memory, etc. Also, the computer program may be distributed to a computer via a communication line, and the computer that receives the distribution may execute the program.

The above-mentioned program may be for realizing part of the above-mentioned functions. Furthermore, the above-mentioned program may be a so-called difference file (difference program) that can realize the above-mentioned functions in combination with a program already recorded in the computer system.

According to some example embodiments of the present disclosure, since a worker is identified based on an identifier unique to the worker, it is possible to prevent errors in linking the worker to the work content.

The present disclosure has been described above with reference to the embodiments, but the present disclosure is not limited to the above-mentioned embodiments. The configuration and details of the present disclosure may be modified in various ways that are understandable to a person skilled in the art within the scope of the present disclosure. And each embodiment may be combined with other embodiments as appropriate.

A part or all of the example embodiment described above can be written as in the supplementary notes below, but is not limited thereto.

### Supplementary Note 1

An analysis device comprising:
a memory configured to store instructions; and
a processor configured to execute the instructions to:
acquire an image including a worker and a marker, the marker being attached to the worker and indicating an identifier unique to the worker;
identify the worker based on the identifier;
specify work content based on a position of the marker; and
output data including the identified worker and the specified work content that are linked to each other.

### Supplementary Note 2

The analysis device according to supplementary note 1, wherein the processor is configured to execute the instructions to specify, based on the marker that further indicates a type of a joint at the position where the marker is attached, the type of the joint.

### Supplementary Note 3

The analysis device according to supplementary note 1 or 2, wherein the processor is configured to execute the instructions to the processor is configured to execute the instructions to specify, based on the position of the marker attached to a position corresponding to a joint of the worker, the position of the joint of the worker.

### Supplementary Note 4

The analysis device according to supplementary note 3, wherein the processor is configured to execute the instructions to specify positions of a plurality of joints of the worker from the image by image recognition, and wherein the processor is configured to execute the instructions to specify the work content based on: at least some of the positions of the plurality of joints of the worker specified by image recognition; and the position of the joint of the worker specified based on the position of the marker.

### Supplementary Note 5

The analysis device according to supplementary note 4, wherein the processor is configured to execute the instructions to replace, among the positions of the plurality of joints of the worker specified by image recognition, the position indicating the same joint as the joint of the worker specified based on the position of the marker, with the position of the joint of the worker specified based on the position of the marker.

### Supplementary Note 6

The analysis device according to supplementary note 1 or 2, wherein the marker is a two-dimensional bar code.

### Supplementary Note 7

The analysis device according to any one of supplementary note 1 to 5, wherein the marker is a light configured to emit light in a color unique to the worker.

### Supplementary Note 8

The analysis device according to any one of supplementary note 1 to 5, wherein the marker is a light configured to emit light in a pattern unique to the worker.

### Supplementary Note 9

An analysis system comprising:
a camera configured to photograph a worker and obtain an image including the worker and a marker, the marker being attached to the worker and indicating an identifier unique to the worker;
a memory configured to store instructions;
a processor configured to execute the instructions to identify the worker based on the identifier, specify the work content based on a position of the marker, and output data including the identified worker and the specified work content that are linked to each other; and
a terminal configured to present the data to a user.

### Supplementary Note 10

An analysis method comprising:
acquiring an image including a worker and a marker, the marker being attached to the worker and indicating an identifier unique to the worker;
identifying the worker based on the identifier; specifying work content based on a position of the marker; and
outputting data including the identified worker and the specified work content that are linked to each other.

### Supplementary Note 11

A program for causing a computer to execute:
acquiring an image including a worker and a marker, the marker being attached to the worker and indicating an identifier unique to the worker;
identifying the worker based on the identifier;
specifying work content based on a position of the marker; and outputting data including the identified worker and the specified work content that are linked to each other.

### Supplementary Note 12

A workwear comprising:
a clothing body for a worker to wear, and a marker attached to the clothing body and indicating an identifier unique to the worker.

Supplementary notes corresponding to supplementary notes 2 to 8 subordinate to supplementary notes 1 may also be provided for each of supplementary notes 9 to 11, with appropriate wording changes.

While preferred embodiments of the invention have been described and illustrated above, it should be understood that these are exemplary of the invention and are not to be considered as limiting. Additions, omissions, substitutions, and other modifications can be made without departing from the scope of the present invention. Accordingly, the invention is not to be considered as being limited by the foregoing description, and is only limited by the scope of the appended claims.

What is claimed is:

1. An analysis device comprising:
a memory configured to store instructions; and
a processor configured to execute the instructions to:
acquire an image including a worker and a marker, the marker being attached to the worker and indicating an identifier unique to the worker;
identify the worker based on the identifier;
specify work content based on a position of the marker; and
output data including the identified worker and the specified work content that are linked to each other.

2. The analysis device according to claim 1, wherein the processor is configured to execute the instructions to specify, based on the marker that further indicates a type of a joint at the position where the marker is attached, the type of the joint.

3. The analysis device according to claim 1, wherein the processor is configured to execute the instructions to the processor is configured to execute the instructions to specify, based on the position of the marker attached to a position corresponding to a joint of the worker, the position of the joint of the worker.

4. The analysis device according to claim 3,
wherein the processor is configured to execute the instructions to specify positions of a plurality of joints of the worker from the image by image recognition, and
wherein the processor is configured to execute the instructions to specify the work content based on: at least some of the positions of the plurality of joints of the worker specified by image recognition; and the position of the joint of the worker specified based on the position of the marker.

5. The analysis device according to claim 4, wherein the processor is configured to execute the instructions to replace, among the positions of the plurality of joints of the worker specified by image recognition, the position indicating the same joint as the joint of the worker specified based on the position of the marker, with the position of the joint of the worker specified based on the position of the marker.

6. The analysis device according to claim 1, wherein the marker is a two-dimensional bar code.

7. The analysis device according to claim 1, wherein the marker is a light configured to emit light in a color unique to the worker.

8. The analysis device according to claim 1, wherein the marker is a light configured to emit light in a pattern unique to the worker.

9. An analysis system comprising:
a camera configured to photograph a worker and obtain an image including the worker and a marker, the marker being attached to the worker and indicating an identifier unique to the worker;
a memory configured to store instructions;
a processor configured to execute the instructions to identify the worker based on the identifier, specify the work content based on a position of the marker, and output data including the identified worker and the specified work content that are linked to each other; and
a terminal configured to present the data to a user.

10. An analysis method comprising:
acquiring an image including a worker and a marker, the marker being attached to the worker and indicating an identifier unique to the worker;
identifying the worker based on the identifier;
specifying work content based on a position of the marker; and
outputting data including the identified worker and the specified work content that are linked to each other.
